(19) United States
(12) Patent Application Publication
(10) Pub. No.: US 2024/0119291 A1
(43) Pub. Date: Apr. 11, 2024

(54) DYNAMIC NEURAL NETWORK MODEL SPARSIFICATION

(71) Applicant: NVIDIA Corporation, Santa Clara, CA (US)

(72) Inventors: Jose M. Alvarez Lopez, Mountain View, CA (US); Pavlo Molchanov, Mountain View, CA (US); Hongxu Yin, San Jose, CA (US); Maying Shen, Santa Clara, CA (US); Lei Mao, San Jose, CA (US); Xinglong Sun, Menlo Park, CA (US)

(21) Appl. No.: 18/203,552

(22) Filed: May 30, 2023

Related U.S. Application Data
(60) Provisional application No. 63/410,803, filed on Sep. 28, 2022.

(51) Int. Cl. G06N 3/082; G06N 3/0495

(52) U.S. Cl. CPC G06N 3/082; G06N 3/0495

(57) ABSTRACT

Machine learning is a process that learns a neural network model from a given dataset, where the model can then be used to make a prediction about new data. In order to reduce the size, computation, and latency of a neural network model, a compression technique can be employed which includes model sparsification. To avoid the negative consequences of pruning a fully pretrained neural network model and on the other hand of training a sparse model in the first place without any recovery option, the present disclosure provides a dynamic neural network model sparsification process which allows for recovery of previously pruned parts to improve the quality of the sparse neural network model.

### RELATED APPLICATION(S)

This application claims the benefit of U.S. Provisional Application No. 63/410,803 (Attorney Docket No. NVIDP1361+/22-SC-1321US01), titled “TOWARDS DYNAMIC SPARSIFICATION BY ITERATIVE PRUNE-GROW LOOKAHEADS” and filed Sep. 28, 2022, the entire contents of which is incorporated herein by reference.

### TECHNICAL FIELD

The present disclosure relates to compression of neural network models through sparsification.

### BACKGROUND

Machine learning is an artificial intelligence technique that involves a computer process learning a neural network model from a given dataset, where the model can then be used to make a prediction about new data. Thus, machine learning allows for the model to be learned from data, instead of being defined as a preconfigured equation. Typically, the neural network model includes a large number of interconnected processing units which are arranged in layers.

As machine learning techniques have made progress towards improving model performance (e.g. accuracy), the costs associated with these improved models has increased, such as the model size, computation, and latency. Besides generally consuming a greater amount of computer resources to run these models, the increased costs can completely hinder deployment to applications that suffer stringent resources, including in particular edge device applications.

In order to address these issues, techniques have been developed to compress neural network models. Usually, compression involves some sparsification of the neural network model, including pruning (i.e. removing) redundant parts (e.g. parameters, connections, etc.) of the model for more efficient storage and computation, thereby providing practical speedup of model execution and reduced memory consumption for model storage. However, there are still limitations associated with current model compression techniques.

For example, most compression techniques involve pruning pretrained models. This requires intensive initial training costs, since the full dense model (with redundancies therein) must first be trained prior to performing any pruning. Other compression techniques aim to avoid this initial training cost by generating a sparse model at initialization or early in the training stage. Unfortunately, generating a sparse model from the beginning will negatively affect the performance of the model, in particular due to a limited number of data samples processed before pruning (such that rich features cannot be learned) and also due to an inability of the model capacity to recover once pruned (such that the rich feature still cannot be learned).

There is thus a need for addressing these issues and/or other issues associated with the prior art. For example, there is a need for providing a dynamic neural network model sparsification process which allows for recovery of previously pruned parts to improve the quality of the sparse neural network model.

### SUMMARY

A method, computer readable medium, and system are disclosed for dynamic neural network model sparsification in which an iteration of at least one iteration of a neural network model sparsification process is performed. During the iteration, an active set of parameters are trained in a neural network model from which a subset of parameters has been pruned. During the iteration, an importance of the subset of parameters pruned from the neural network model is estimated by freezing the active set of parameters in the neural network model and training the subset of parameters in the neural network model. During the iteration, the active set of parameters in the neural network model are updated, based on the importance of the subset of parameters pruned from the neural network model.

### BRIEF DESCRIPTION OF THE DRAWINGS

FIG. 1 illustrates a flowchart of a dynamic neural network sparsification method, in accordance with an embodiment.

FIG. 2 illustrates an iterative dynamic neural network sparsification method, in accordance with an embodiment.

FIG. 3 illustrates a block diagram of a dynamic neural network sparsification process, in accordance with an embodiment.

FIGS. 4-5 illustrate pseudocode for an exemplary algorithmic implementation of the dynamic neural network sparsification process of FIG. 3.

FIG. 6 illustrates a flowchart of a method for using a neural network model in a downstream task, in accordance with an embodiment.

FIG. 7A illustrates inference and/or training logic, according to at least one embodiment;

FIG. 7B illustrates inference and/or training logic, according to at least one embodiment;

FIG. 8 illustrates training and deployment of a neural network, according to at least one embodiment;

FIG. 9 illustrates an example data center system, according to at least one embodiment.

### DETAILED DESCRIPTION

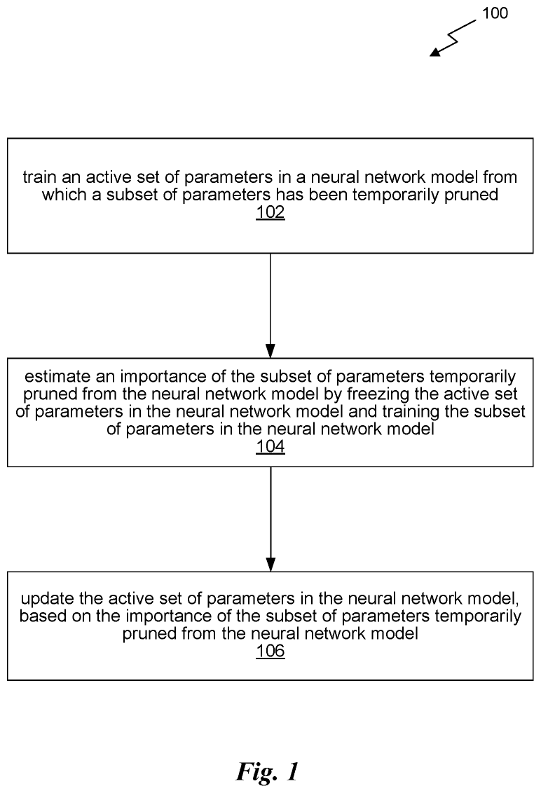

FIG. 1 illustrates a flowchart of a dynamic neural network sparsification method 100, in accordance with an embodiment. The method 100 may be performed by a device, which may be comprised of a processing unit, a program, custom circuitry, or a combination thereof, in an embodiment. In another embodiment a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

The method 100 may be performed during an iteration of a neural network model sparsification process. The neural network model sparsification process refers to a process of generating a sparse (e.g. compressed) neural network model. For example, the neural network model sparsification process may generate a neural network model with one or more redundancies removed therefrom. As another example, the neural network model sparsification process may reduce a size of a given (e.g. original, dense, etc.) neural network model, by generating a sub-network from the given neural network model. This sparsification may be accomplished by removing one or more parameters from the given neural network model, as described in more detail below.

The neural network model sparsification process may include a single iteration, in an embodiment, or a plurality of iterations, in another embodiment. The method 100 may be repeated for each iteration of the neural network model sparsification process. In general, each iteration may function to generate a more sparse, or more compressed, neural network model from a prior version of the neural network model (i.e. from the neural network model given for that iteration). The neural network model sparsification process may target a defined sparsity, and in this case the neural network model sparsification process may be iterated until the target sparsity is achieved, or in other words until a neural network model is generated with (or within a defined range of) the defined sparsity.

In operation 102, an active set of parameters are trained in a neural network model from which a subset of parameters has been temporarily pruned. The neural network model refers to a machine learning model that is represented as a neural network. The embodiments disclosed herein may also refer to the neural network model as a “neural network” or simply a “network.” The neural network model may be configured to include a plurality of layers, channels, and/or weights.

The parameters of the neural network model referred to as being “active” and “temporarily pruned” include any type of parameter that can be trained in the neural network model. In one embodiment, the parameters may be weights in the neural network model. In another embodiment, the parameters may be channels in the neural network model. For a set of all parameters in the neural network model, a first portion (subset) may be active and a second portion (subset) may be temporarily pruned (or “inactive”). It should be noted that the first portion may be selected by some criteria and the second portion may then include all remaining parameters, or vice versa.

In any case, the active set of parameters are those parameters that are in some way indicated for training in the neural network model, and the temporarily pruned parameters are those parameters that are not indicated for training in the neural network model. In an embodiment, a mask may define the active set of parameters and the subset of parameters temporarily pruned from the neural network model. For example, each parameter may be represented by a bit that is set to a first value (e.g. 1) when the parameter is active and a second value (e.g. 0) when the parameter is temporarily pruned. For each iteration of the neural network model sparsification process, the mask may be updated, as described in more detail below. By using the mask, the temporarily pruned parameters may be only be considered frozen with respect to the neural network model, and accordingly are maintained for subsequent activation in the neural network model, as described below.

In an embodiment, the active set of parameters may be randomly selected for an initial iteration of the neural network model sparsification process. In another embodiment, for any iteration of the neural network model sparsification process subsequent to the initial iteration, the active set of parameters may be selected during an immediate prior iteration of the neural network model sparsification process. In an embodiment, a number of active parameters to be used (i.e. during each iteration of the at least one iteration of the neural network model sparsification process) may be predefined. In an embodiment, the neural network model may be a sparse neural network model having a predefined number of active parameters.

As mentioned, the active set of parameters are trained in the neural network model, and accordingly the subset of parameters may first be temporarily pruned from the neural network model prior to training the active set of parameters in the neural network model. In an embodiment, the temporary pruning may be unstructured (i.e. to include the temporary pruning of single weights in the neural network model). In another embodiment, the temporary pruning may be structured (i.e. to include the temporary pruning of channels in the neural network model).

The training described herein with respect to the neural network model may refer to training the neural network model for any desired downstream task. In an embodiment, the downstream task may be a computer vision task. For example, the computer vision task may refer to image classification, object detection, segmentation, etc. In particular, the neural network model may be trained to predict a particular type of output (e.g. object detection) for a given input (e.g. an image). In an embodiment, the neural network model may be trained using a set of training data representative of the downstream task.

In operation 104, an importance of the subset of parameters temporarily pruned from the neural network model is estimated by freezing the active set of parameters in the neural network model and training the subset of parameters in the neural network model. The importance of the subset of parameters temporarily pruned from the neural network model refers to a valuation computed according to a defined algorithm. In an embodiment, the importance is estimated for one or more parameters temporarily pruned from the neural network model. In another embodiment, the importance is estimated for each of the parameters temporarily pruned from the neural network model.

In an embodiment, the importance of a parameter may be estimated using a predefined algorithm. In an embodiment, the importance of a parameter may refer to magnitude importance. In another embodiment, the importance of a parameter may refer to Taylor importance.

As disclosed above, in order to estimate the importance of the subset of parameters temporarily pruned from the neural network model, the active set of parameters in the neural network model are frozen and subsequently the prior (temporarily) pruned subset of parameters are trained in the neural network model. Thus, the training of the prior (temporarily) pruned parameters may be the basis for estimating the importance of such parameters. In an embodiment, freezing the active set of parameters in the neural network model may refer to (temporarily) deactivating the active set of parameters already trained in the neural network model. In an embodiment, the subset of parameters that were previously (temporarily) pruned from the neural network model may also be (temporarily) re-activated for training, for example, with their most recently used value. In an embodiment, the freezing and the re-activating may be performed by updating the mask (i.e. to indicate which parameters are active and which parameters are frozen).

In operation 106, the active set of parameters in the neural network model are updated, based on the importance of the subset of parameters temporarily pruned from the neural network model. It should be noted that with respect to the present embodiment, the “active set of parameters” of the present operation 106 refers to the initial active set of parameters defined for the method 100. Updating the active set of parameters in the neural network model refers to updating which parameters in the neural network model are included in the active set (i.e. which parameters are to be active in the neural network model) and which parameters in the neural network model are not included in the active set (i.e. which parameters are to be pruned from the neural network model).

In an embodiment, updating the active set of parameters in the neural network model may be performed by defining the updated active set of parameters in the mask (i.e. updating the mask to indicate which parameters are to be active in the neural network model and which parameters are to be pruned from the neural network model).

The active set of parameters may be updated based upon any desired policy that considers the importance of the subset of parameters pruned from the neural network model. In an embodiment, an importance of the parameters in the initial active set of parameters (from operation 102) may additionally be estimated. In this case, the active set of parameters may be updated based upon the importance of all (active and pruned) parameters. In an embodiment, the active set of parameters may be updated to include a defined number of parameters with highest importance from among the active set of parameters and the pruned subset of parameters. To this end, updating the active set of parameters may include growing the active set of parameters with one or more of the parameters in the subset of parameters previously pruned from the neural network model.

To this end, the method 100 may provide for a dynamic neural network sparsification process by which parameters are temporarily pruned from the neural network model during an initial training step and then are re-evaluated (for re-activation) with respect to the neural network model during a subsequent training step. In an embodiment, the active set of parameters may be trained over a first plurality of iterations to stabilize the neural network model and to exploit the neural network model to improve its performance with respect to a defined performance goal. In another embodiment, the subset of parameters may be trained over a second plurality of iterations with an assumption of stability of the neural network model and to exploit the neural network model to maximize its performance with respect to the defined performance goal.

In an embodiment, an additional iteration of the neural network model sparsification process may be performed, based on the updated active set of parameters. In particular, the method 100 may be repeated with respect to the updated active set of parameters (and in turn the updated set of pruned parameters). As mentioned above, the neural network model sparsification process may include a number of iterations until a target sparsity for the neural network model is achieved. Once the target sparsity is achieved, any parameters currently marked as temporarily pruned (or inactive) may be permanently pruned (e.g. removed) from the neural network model and in turn the neural network model may be output (e.g. for use in the downstream task).

Further embodiments will now be provided in the description of the subsequent figures. It should be noted that the embodiments disclosed herein with reference to the method 100 of FIG. 1 may apply to and/or be used in combination with any of the embodiments of the remaining figures below.

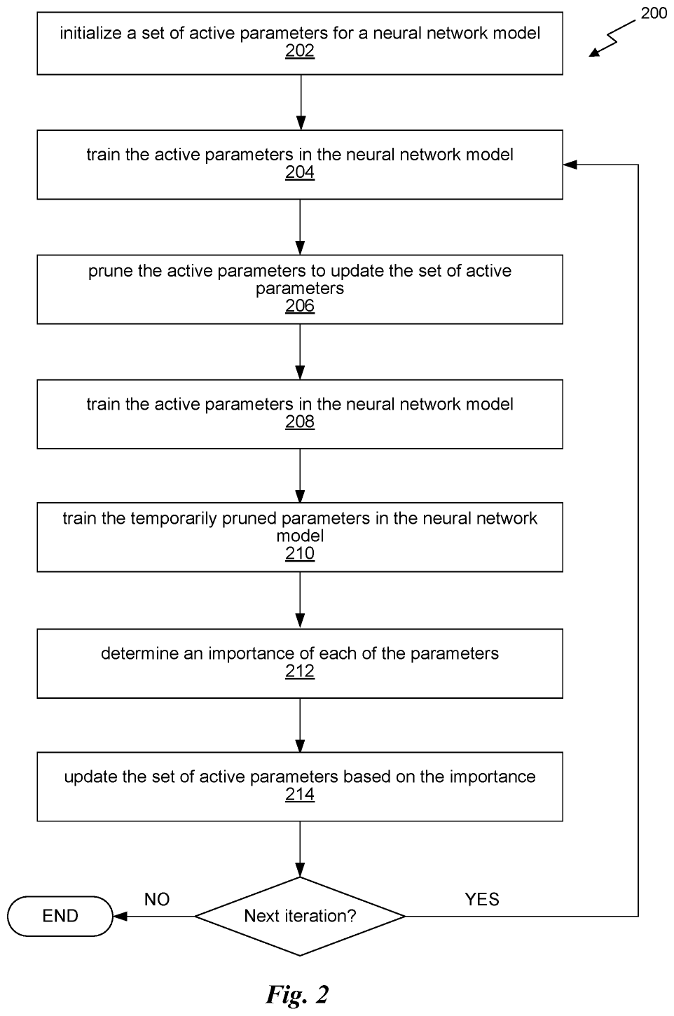

FIG. 2 illustrates an iterative dynamic neural network sparsification method 200, in accordance with an embodiment. The method 200 may be performed in accordance with the method 100 of FIG. 1. For example, the method 200 may one example multiple iterations of the neural network sparsification described above with respect to FIG. 1. Of course, however, the method 100 may be performed in the context of any of the other embodiments described herein. The definitions and embodiments described above may equally apply to the description of the present embodiment.

In operation 202, a set of active parameters for a neural network model is initialized. In an embodiment, the set of active parameters may be initialized randomly. For example, the parameters to be activated for the neural network model may be randomly selected. Remaining parameters may be considered pruned from the neural network model. In an embodiment, a mask may be generated to indicate, for each parameter, whether the parameter is active or pruned.

In operation 204, the active parameters are trained in the neural network model. In an embodiment, the active parameters may be trained for a first defined number of iterations. In an embodiment, importance of the active parameters may be estimated while training the active parameters in the neural network model.

In operation 206, the active parameters are pruned to update the set of active parameters. In an embodiment, the active parameters may be pruned based on the importance estimated for the active parameters. In an embodiment, a defined number of active parameters with greatest importance may be selected as the updated set of active parameters, with remaining parameters considered pruned from the neural network model. In an embodiment, the mask may be updated to indicate the updated set of active parameters.

In operation 208, the active parameters are trained in the neural network model. Thus, the active parameters in the updated set may be trained in the neural network model. In an embodiment, the active parameters may be trained for a second defined number of iterations, which may be different from the first defined number of iterations over which the prior set of active parameters were trained in the neural network model. In an embodiment, importance of the active parameters in the updated set of active may be estimated while training these active parameters in the neural network model.

In operation 210, the pruned parameters are trained in the neural network model. In an embodiment, the pruned parameters may be temporarily activated for the training thereof. For example, the pruned parameters may be temporarily activated by updating the mask. In an embodiment, the pruned parameters may be temporarily activated with their most recently used value.

In an embodiment, the prior trained active parameters (from operation 208) may be frozen while training the temporarily pruned (i.e. inactive) parameters. For example, the prior trained active parameters may be frozen by updating the mask. In an embodiment, the temporarily pruned parameters may be trained for a third defined number of iterations, which may be different from the first and second defined numbers of iterations over which both prior sets of active parameters were trained, respectively. In an embodiment, an importance of the temporarily pruned parameters may be estimated during their training.

In operation 212, an importance of each of the parameters is determined (i.e. both from the active set and the pruned set). As mentioned above, the importance of the active parameters may be estimated during the training thereof, while the importance of the pruned parameters may be determined during the training thereof.

In operation 214, the set of activate parameters is updated based on the importance. In an embodiment, a fraction of the temporarily pruned parameters may be activated. In an embodiment, a defined number of parameters with greatest importance may be selected as the updated set of active parameters, with remaining parameters considered (e.g. at least temporarily) pruned from the neural network model. In an embodiment, the mask may be updated to indicate the updated set of active parameters.

In decision 216, it is determined whether another iteration of neural network sparsification is to be performed. In an embodiment, the determination may be based on whether a target sparsity has been achieved for the neural network model. For example, the method 200 may continue iterating until the target sparsity has been achieved.

When it is determined that another iteration of neural network sparsification is not to be performed, then the method 200 ends. When it is determined that another iteration of neural network sparsification is to be performed, the method 200 returns to operation 204 to train the latest set of active parameters obtain in operation 214.

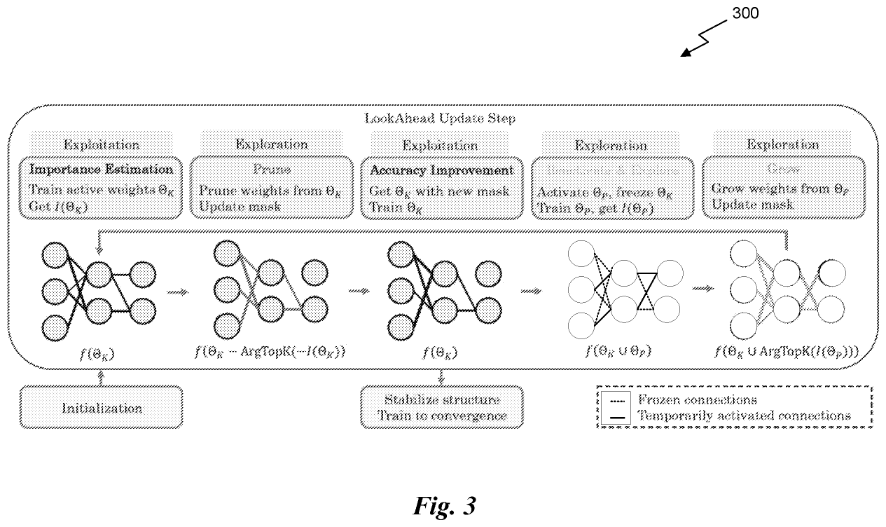

FIG. 3 illustrates a block diagram of a dynamic neural network sparsification process 300, in accordance with an embodiment. The process 300 may be performed in accordance with the method 200 of FIG. 2 and/or in the context of any of the other embodiments described herein. The definitions and embodiments described above may equally apply to the description of the present embodiment.

It should be noted that the neural network sparsification process 300 is described in the present Figure as specifically related to achieving unstructured sparsity via unstructured pruning (i.e. the pruning of single weights in the neural network model). However, the neural network sparsification process 300 may equally relate to achieving structured sparsity via to structured pruning (i.e. the pruning of channels in the neural network model). Any differences in the process 300 in this regard will be explained further below.

The present embodiment considers a neural network with weights Θ∈ [symbol] ^{m}. A binary mask B={Bᵢ}₁^{m}, Bᵢ∈{0,1} to identify the parameters of the network that are meant to be kept Θ_{K}={Θᵢ; Bᵢ=1}, and those to be removed Θ_{P}={Θᵢ; Bᵢ=0}, such that Θ=ΘP. The present embodiment assumes a target sparsity S, i.e

$$. S = \frac{{‖ {Θ}_{P} ‖}_{0}}{{‖ Θ ‖}_{0}} ,$$

where ∥·∥₀ is the L₀-norm. Given a training dataset D consisting of N input-output samples {(xᵢ, yᵢ)}ᵢ₌₁^{N}, the the learning and sparsification of the network is formulated as solving an optimization problem of the form in Equation 1.

$$\begin{matrix}min \\ {Θ}_{K} ⊆ Θ\end{matrix} {𝔼}_{( {x}^{i} , {y}^{i} ) \sim D} [ ℓ ( f ( {Θ}_{K} ; {x}^{i} ) , {y}^{i} ) ] , \qquad Equation 1$$

$$s . t . {‖ {Θ}_{K} ‖}_{0} \leq ( 1 - S ) \cdot m ,$$

$$where ℓ ( \cdot ) is the training loss .$$

In order to solve Equation 1, Θ_{K} and Θ_{P} are first randomly initialized such that ∥Θ_{K}∥₀=(1−S)·m, and then a LookAhead update step, described below, is iteratively run throughout training to update the sparse architecture Θ_{K} on-the-fly until reaching the total number of LookAhead update steps needed to achieve the target sparsity S. The updated sparse architecture is defined concretely by a pruning stage which removes a “redundant” fraction of parameters from Θ_{K} then a growing stage which grows an “important” fraction of parameters from Θ_{P} back to Θ_{K}. The new important weights that are selected to grow back (i.e. activate) from Θ_{P} is handled in a Reactivate & Explore stage leveraging optimistic initialization to alleviate exploration greediness. Further, each prune and grow session is scheduled with interleaved training stages to enforce exploitation-exploration.

LookAhead

LookAhead refers to a neural network sparsification process, which can be iterated as an update step to achieve a target sparsity for a neural network model. Each LookAhead step consists of five stages: Importance Estimation, Prune, Accuracy Improvement, Reactivate & Explore, and Grow.

Importance Estimation

The process starts with an initial training stage to exploit the current selected architecture Θ_{K} that has the target sparisty of S. The kept weights Θ_{K} are trained for H iterations while measuring the parameters importance. Without loss of generality, magnitude importance is used for unstructured sparsity and Taylor importance used for structured sparsity.

Prune

In the second stage, a redundant fraction of currently active parameters Θ_{K} are removed (e.g. set as inactive) based on the importance estimated in the previous stage. The parameters that are pruned are given by ArgTopK(−|Θ_{K}|), n), where |·| measures the weight magnitude, and ArgTopK(·, k) gives the indices of the top-k elements of its input. After pruning, the mask elements are set for the pruned parameters in B to 0, and sets Θ_{K}, Θ_{P} are also updated accordingly.

Note that the weight values Θ_{K} are not actually changed and zeroed out, but rather they are kept and the weights masked during the forward pass as f(Θ⊙B; xⁱ). To determine n, the number of parameters to update each time, a cosine decay function ƒ_{decay} is used, such that the number of neurons to be updated is defined as n=ƒ_{decay} (t; α,T)·m·(1−S), where T is the total number of LookAhead update steps, t is the current update step, m is the total number of parameters in Θ, and α is the initial parameter update ratio.

Accuracy Improvement

With the newly selected set of Θ_{K}, another training stage is carried out for J iterations on Θ_{K} with the goal to stabilize and fully exploit the architecture just selected to improve its performance.

Reactivate & Explore

The pruned weights Θ_{P} are now explored for an updated better sparse architecture with insights drawn from optimistic initialization approaches. With this strategy, all the actions are first deemed to be optimal and then are explored at least multiple times to challenge the assumption. This is performed by first temporarily activating all of the potentially to-be-grown connections Θ_{P} by setting all elements in B to 1 then exploring by quickly updating them for K iterations while freezing Θ_{K} to look ahead the performance if growing these parameters back to the current network. This freezing preserves the currently selected architecture for a stable exploration. Also, note that in the previous Prune stage, the actual weight values Θ are not zeroed out but instead that only the mask B is changed. When reactivated, the previously pruned weights Θ_{P} inherit their MRU (i.e., Most Recently Used values) from before they were turned off. This training stage with Θ_{K} frozen can be formulated per Equation 2.

$${min}_{{Θ}_{P}} \frac{1}{K} {\sum }_{i = 1}^{K} ℓ ( f ( {Θ}_{P} ⋃ {Θ}_{K} ; {x}^{i} ) , {y}^{i} ) \qquad Equation 2$$

Grow

A fraction of parameters in Θ_{P} are activated and added back to Θ_{K} based on the importance estimated in the previous stage. During the previous stage, Reactivate & Explore, Θ_{P} is quickly trained and readjusted with Θ_{K} frozen to reflect the performance if they are added back to the current network. The newly updated weights Θ_{P} allow for a solid choice of which weights are worth continued exploration and for being grown back. Thus, the parameters given by ArgTopK(|Θ_{P}|, n) are grown back and the corresponding mask elements in B are set to 1. The sets Θ_{K} and Θ_{P} are also updated accordingly. It should be noted that in the present Grow stage n is the same as Prune, such that model sparsity remains the same after one prune-grow. The process then cycles back to Importance Estimation for another LookAhead step.

### SUMMARY

By combining the Reactivate & Explore and Grow with K=1, the magnitude criterion of LookAhead can be reformulated as

$$Prior ( \vert {Θ}_{P} \vert ) + \frac{\partial }{\partial {Θ}_{P}} {\sum }_{i = 1}^{\vert B \vert} ℓ ( f ( {Θ}_{K} ⋃ {Θ}_{P} ; {x}^{i} ) , {y}^{i} ) ,$$

leveraging prior importance information in previous update steps while also performing posterior correction and adjust based on newly selected Θ_{K} in the current LookAhead update step.

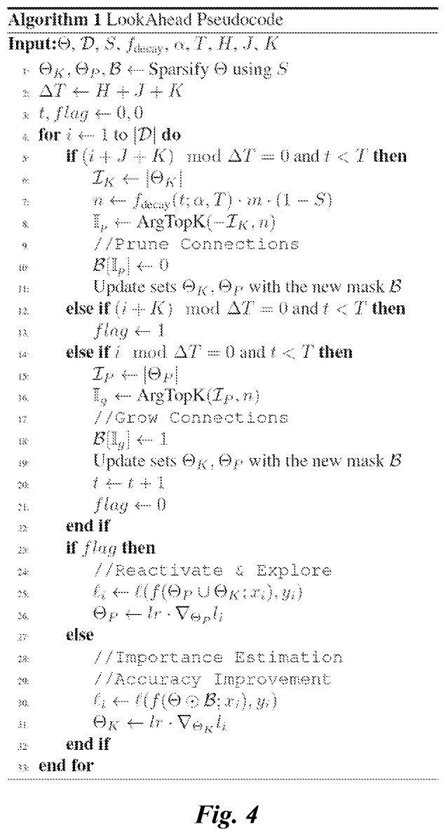

FIG. 4 illustrates pseudocode for an exemplary algorithmic implementation of the process of FIG. 3.

Structured Sparsity

The embodiments below describe the dynamic neural network sparsification process 300 of FIG. 3 in the context of achieving structured sparsity. In particular, the embodiments relate to LookAhead implemented with a latency-constrained structured sparsity setting. Any differences in the process 300 in this regard will be explained herein.

For the neural network with L layers in total, its parameters are represented as Θ=∪ₗ₌₁^{L}=Θₗ, s.t. Θₗ∈ [symbol] ^{C}^{ₒᵤₜ}^{^{l}}^{×C}^{ᵢₙ}^{^{l}}^{×K}^{^{l}}^{×K}^{^{l}}. For the binary mask B indicating pruned and kept parameters, B=∪ₗ₌₁^{L} B^{l},B^{l}∈ [symbol] ^{C}^{ₒᵤₜ}^{^{l}}, B^{l}∈{0,1}^{C}^{ₒᵤₜ}^{^{l}} where Cₒᵤₜ^{l} represents the number of output channels of layer l. As further disclosed herein, Cₒᵤₜ^{l} is denoted as m^{l} for simplicity. Unlike the element-wise multiplication of model parameters and corresponding binary mask, the model masking producing sparse model weights is represented per Equation 3.

Θ●B=∪ₗ₌₁^{L}Θ^{l}⊙diag(B^{l}), Equation 3
where diag is a diagonalization operation broadcasting B^{l} to the same shape as Θ^{l}.

In PyTorch, this would be represented per Equation 4.

Θ●B=∪ₗ₌₁^{L}Θ^{l}⊙B^{l}.view(−1,1,1,1) Equation 4

Moreover, Θ_{K} represents kept channels, expressed as Θ_{K}={∪ₗ₌₁^{L}∪ᵢ₌₁^{m}^{^{l}}Θᵢ^{l}; Bᵢ^{l}=1}, and Θ_{P}={∪ₗ₌₁^{L}∪ᵢ₌₁^{m}^{^{l}}Θᵢ^{l}; Bᵢ^{l}=0}. Finally, p^{l} is used to define the active number of channels at layer l, expressed as p^{l}=∥B^{l}∥₀.

For latency-constrained structured sparsification, a resource-constrained pruning method is used with LookAhead. The pruning step is formulated as a global cost-constraint importance maximization problem, where the latency benefits incurred are considered every time a channel is removed from one of the layers of the network. Similarly, the growing part is formulated as a cost-constraint importance maximization problem.

Given a global resource constraint C defining the maximum amount of resources allowed to be used, the aim is to find a set of channels defining a sub-network that achieves the best performance under the constraint C. In an embodiment, C represents the inference latency for a target hardware platform. With the structured latency constraint, learning of the network sparsification (Equation 1 above) now becomes Equation 5.

$$\begin{matrix}min \\ Θ , B\end{matrix} \frac{1}{N} {\sum }_{i = 1}^{\frac{N}{\vert B \vert}} ℓ ( f ( Θ B ; {x}^{i} ) , {y}^{i} ) , \qquad Equation 5$$

$$s . t . {\sum }_{l = 1}^{L} {T}^{l} ( {p}^{l - 1} , {p}^{l} ) \leq C ,$$

where T^{l}(p^{l-1}, p^{l}) defines the layer latency at layer l with p^{l-1} active input channels and p^{l} active output channels.

In order to obtain the layer latency T^{l}(p^{l-1}, p^{l}), a pre-built layer-wise look-up table recording the latency at certain channel number and kernel dimension configuration is used. With this latency look-up table, a potential latency reduction value Rⱼ^{l} is associated to each jth channel of layer l, computer per Equation 6.

Rⱼ^{l}=T^{l}(p^{l-1},j)−T^{l}(p^{l-1},j−1),1≤j≤p^{l} Equation 6

Rⱼ^{l} estimates the potential latency saving if the corresponding channel is pruned. In order to estimate the performance of the selected sub-network, the importance score Iⱼ^{l} is measured for each jth channel of layer l. The importance score metric adopted here is Taylor importance, which is evaluated per Equation 7.

Iⱼ^{l}=|g_{γ}_{ⱼ}_{^{l}}γⱼ^{l}+g_{β}_{ⱼ}_{^{l}}βⱼ^{l}| Equation 7
where γ and β are the BatchNorm layer's weight and bias.

With R and I calculated, the channel pruning is formulated as a Knapsack problem where we try to maximize the total importance but under the latency constraint C, per Equation 8.

$$\begin{matrix}max {\sum }_{l = 1}^{L} {\sum }_{j = 1}^{{p}^{l}} {I}_{j}^{l} , s . t . {\sum }_{l = 1}^{L} {\sum }_{j = 1}^{{p}^{l}} {R}_{j}^{l} \leq C , \\ 0 \leq {p}^{l} \leq {m}^{l} , {I}_{1}^{l} \geq {I}_{2}^{l} \geq … {I}_{{p}^{l}}^{l}\end{matrix} \qquad Equation 8$$

Accordingly, in an embodiment the channels are ranked globally by importance and their latency contribution is considered. Concretely, if the least important channel at layer l is pruned, the number of active channels will change from p^{l} to p^{l}−1, leading to a latency reduction Rₚ_{^{l}}^{l} assigned as this channel's importance score. For solving Equation 8, an augmented Knapsack solver Knapsack(V,W,C) has been developed, where V and W are lists of values and weights for each item and C is the global resource constraint. Knapsack(V,W,C) returns the items achieving maximum value while the accumulated weight is below the global constraint C.

Each LookAhead update step consists of alternative prune-and-grow to fully explore the sparse architecture. With a structured latency-constrained setting, during growing, the model latency is also taken into account to prevent some latency-costly channels getting added back. A latency-constrained growing step based on the Knapsack scheme is provided, similar to the latency-constrained pruning detailed above. Similarly, the latency look-up table is used to associate a potential latency addition value Aⱼ^{l} to each jth channel of layer l, computed per Equation 9.

Aⱼ^{l}=T^{l}(p^{l-1},j)−T^{l}(p^{l-1},j−1),(p^{l}+1)≤j≤m^{l} Equation 9

Aⱼ^{l} estimates the potential latency increase if the corresponding channel is grown. The importance of the grown channel I is then estimated similarly using a Taylor importance metric. With A and I calculated, the channel growing is treated as a Knapsack problem to maximize the regrown importance but under the assigned growing latency budget G, per Equation 10.

$$\begin{matrix}max {{\sum }^{L}}_{l = 1} {{\sum }^{{p}^{l} + {g}^{l}}}_{j = {p}^{l} + 1} {I}_{j}^{l} , s . t . {{\sum }^{L}}_{l = 1} {{\sum }^{{p}^{l} + {g}^{l}}}_{j = {p}^{l} + 1} {A}_{j}^{l} \leq G , \\ 0 \leq {p}^{l} + {g}^{l} \leq {m}^{l} , {I}_{{p}^{l} + 1}^{l} \geq {I}_{{p}^{l} + 2}^{l} \geq … {I}_{{p}^{l} + {g}^{l}}^{l}\end{matrix} \qquad Equation 10$$

Here, g^{l} would be the number chosen to grow back for layer l. Similarly, a ranking on the channels is imposed based on the importance for channel latency assignment. During growing, if the most important channel is grown from Θ_{P}, the number of active channels will change from p^{l} to p^{l}+1, leading to a latency addition Aₚ_{^{l}}^{l} assigned as this channel's importance score. The augmented Knapsack solver Knapsack(V,W,C) is also used here to solve this constrained optimization problem.

Given C as the final targeted latency, the total latency of the model is gradually decreased using an exponential scheduler. Suppose the total number of update steps is T, then the latency target at each step t is C¹>C²> . . . >C^{T}=C. A latency budget is also assigned to the model at each update step to grow an amount of connections. The grown latency budget at update step t could also be determined by an exponential scheduler or cosine annealing scheduler. However, a latency budget given by G^{t}=α·(C^{t}−C^{t-1}) yields good performance. In an embodiment, α=0.75.

In summary, in the prune step, the Knapsack latency-constrained pruning is applied as on the kept parameters Θ_{K}; and in the grow step, the Knapsack latency-constrained growing is applied on the removed parameters Θ_{P}. The scheduled {C^{I}, . . . ,C^{T}} and {G^{I}, . . . ,G^{T}} is used to control the amount pruned and grown latency-wise at each LookAhead step. The other parts and the overall procedure is the same as described above for the unstructured sparsity setting.

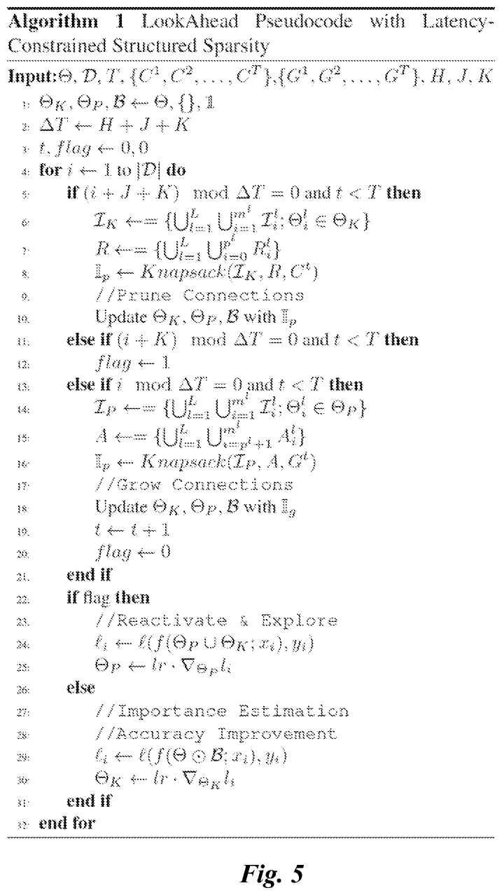

FIG. 5 illustrates pseudocode for an exemplary algorithmic implementation of the latency-constrained implementation for the pseudocode of FIG. 4.

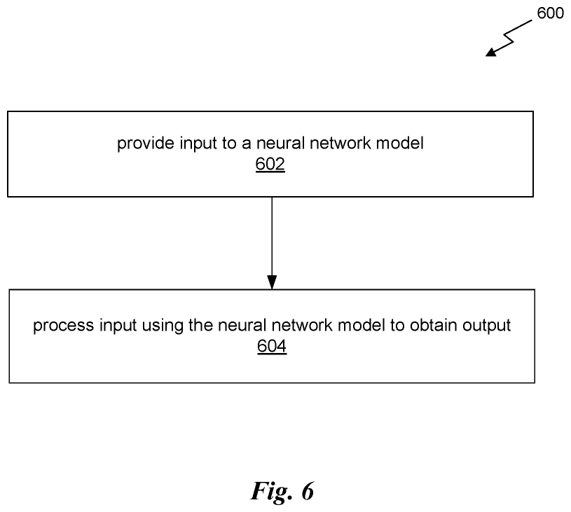

FIG. 6 illustrates a flowchart of a method 400 for using a neural network model in a downstream task, in accordance with an embodiment. The method 400 may be performed using the sparse neural network model created in accordance with any of the methods and/or system described above. The definitions and embodiments described above may equally apply to the description of the present embodiment.

In operation 602, input is provided to a neural network model. The input may be any data intended for processing by the neural network model. In an embodiment, the input may be in a format which the neural network model is configured to be able to process.

In operation 604, the input is processed by the neural network model to obtain output. The input may be processed using the parameters of the neural network model, such as the channels, weights, layers, etc. In an embodiment, the neural network model is a sparse model trained to make a certain type of prediction given an input. Thus, the output is a prediction or inference made by the neural network model based upon the input.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

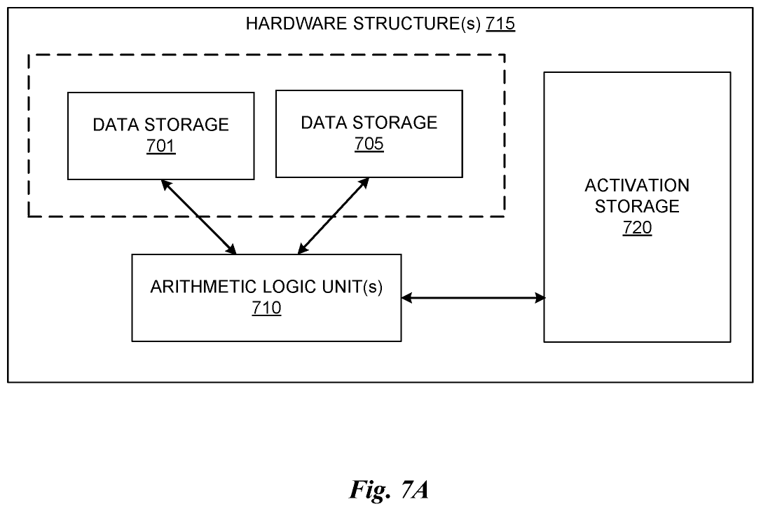

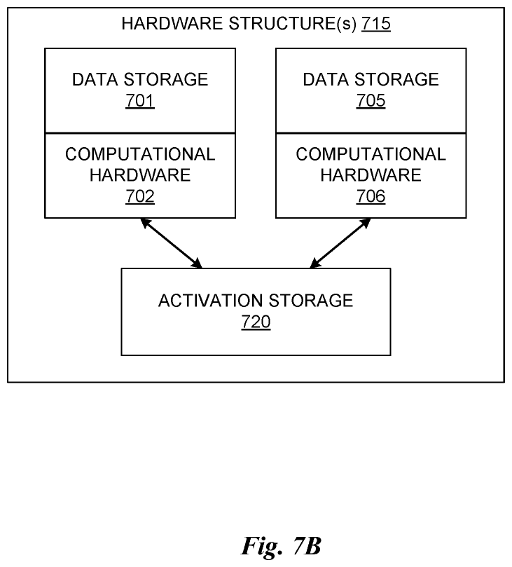

As noted above, a deep learning or neural learning system needs to be trained to generate inferences from input data. Details regarding inference and/or training logic 715 for a deep learning or neural learning system are provided below in conjunction with FIGS. 7A and/or 7B.

In at least one embodiment, inference and/or training logic 715 may include, without limitation, a data storage 701 to store forward and/or output weight and/or input/output data corresponding to neurons or layers of a neural network trained and/or used for inferencing in aspects of one or more embodiments. In at least one embodiment data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 701 may be included with other on-chip or off-chip data storage, including a processor's L1, L2, or L3 cache or system memory.

In at least one embodiment, any portion of data storage 701 may be internal or external to one or more processors or other hardware logic devices or circuits. In at least one embodiment, data storage 701 may be cache memory, dynamic randomly addressable memory (“DRAM”), static randomly addressable memory (“SRAM”), non-volatile memory (e.g., Flash memory), or other storage. In at least one embodiment, choice of whether data storage 701 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a data storage 705 to store backward and/or output weight and/or input/output data corresponding to neurons or layers of a neural network trained and/or used for inferencing in aspects of one or more embodiments. In at least one embodiment, data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 705 may be included with other on-chip or off-chip data storage, including a processor's L1, L2, or L3 cache or system memory. In at least one embodiment, any portion of data storage 705 may be internal or external to on one or more processors or other hardware logic devices or circuits. In at least one embodiment, data storage 705 may be cache memory, DRAM, SRAM, non-volatile memory (e.g., Flash memory), or other storage. In at least one embodiment, choice of whether data storage 705 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 701 and data storage 705 may be separate storage structures. In at least one embodiment, data storage 701 and data storage 705 may be same storage structure. In at least one embodiment, data storage 701 and data storage 705 may be partially same storage structure and partially separate storage structures. In at least one embodiment, any portion of data storage 701 and data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710 to perform logical and/or mathematical operations based, at least in part on, or indicated by, training and/or inference code, result of which may result in activations (e.g., output values from layers or neurons within a neural network) stored in an activation storage 720 that are functions of input/output and/or weight parameter data stored in data storage 701 and/or data storage 705. In at least one embodiment, activations stored in activation storage 720 are generated according to linear algebraic and or matrix-based mathematics performed by ALU(s) 710 in response to performing instructions or other code, wherein weight values stored in data storage 705 and/or data 701 are used as operands along with other values, such as bias values, gradient information, momentum values, or other parameters or hyperparameters, any or all of which may be stored in data storage 705 or data storage 701 or another storage on or off-chip. In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALUs 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 701, data storage 705, and activation storage 720 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., Flash memory), or other storage. In at least one embodiment, activation storage 720 may be completely or partially within or external to one or more processors or other logical circuits. In at least one embodiment, choice of whether activation storage 720 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 715 illustrated in FIG. 7A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, data storage 701 and data storage 705, which may be used to store weight values and/or other information, including bias values, gradient information, momentum values, and/or other parameter or hyperparameter information. In at least one embodiment illustrated in FIG. 7B, each of data storage 701 and data storage 705 is associated with a dedicated computational resource, such as computational hardware 702 and computational hardware 706, respectively. In at least one embodiment, each of computational hardware 706 comprises one or more ALUs that perform mathematical functions, such as linear algebraic functions, only on information stored in data storage 701 and data storage 705, respectively, result of which is stored in activation storage 720.

In at least one embodiment, each of data storage 701 and 705 and corresponding computational hardware 702 and 706, respectively, correspond to different layers of a neural network, such that resulting activation from one “storage/computational pair 701/702” of data storage 701 and computational hardware 702 is provided as an input to next “storage/computational pair 705/706” of data storage 705 and computational hardware 706, in order to mirror conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage computation pairs 701/702 and 705/706 may be included in inference and/or training logic 715.

### Neural Network Training and Deployment

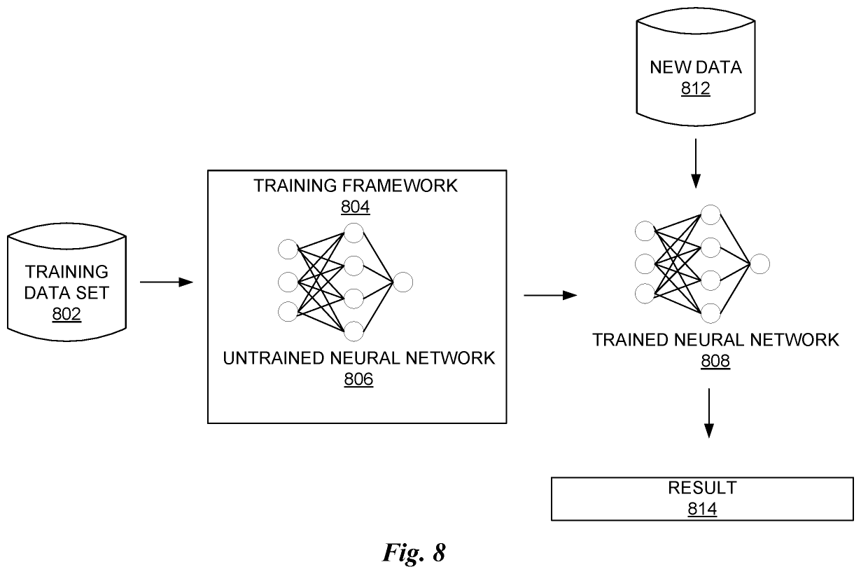

FIG. 8 illustrates another embodiment for training and deployment of a deep neural network. In at least one embodiment, untrained neural network 806 is trained using a training dataset 802. In at least one embodiment, training framework 804 is a PyTorch framework, whereas in other embodiments, training framework 804 is a Tensorflow, Boost, Caffe, Microsoft Cognitive Toolkit/CNTK, MXNet, Chainer, Keras, Deeplearning4j, or other training framework. In at least one embodiment training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having known output and the output of the neural network is manually graded. In at least one embodiment, untrained neural network 806 is trained in a supervised manner processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on known input data, such as new data 812. In at least one embodiment, training framework 804 trains untrained neural network 806 repeatedly while adjust weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, wherein untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map, which is a type of trained neural network 808 capable of performing operations useful in reducing dimensionality of new data 812. In at least one embodiment, unsupervised training can also be used to perform anomaly detection, which allows identification of data points in a new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new data 812 without forgetting knowledge instilled within network during initial training.

### Data Center

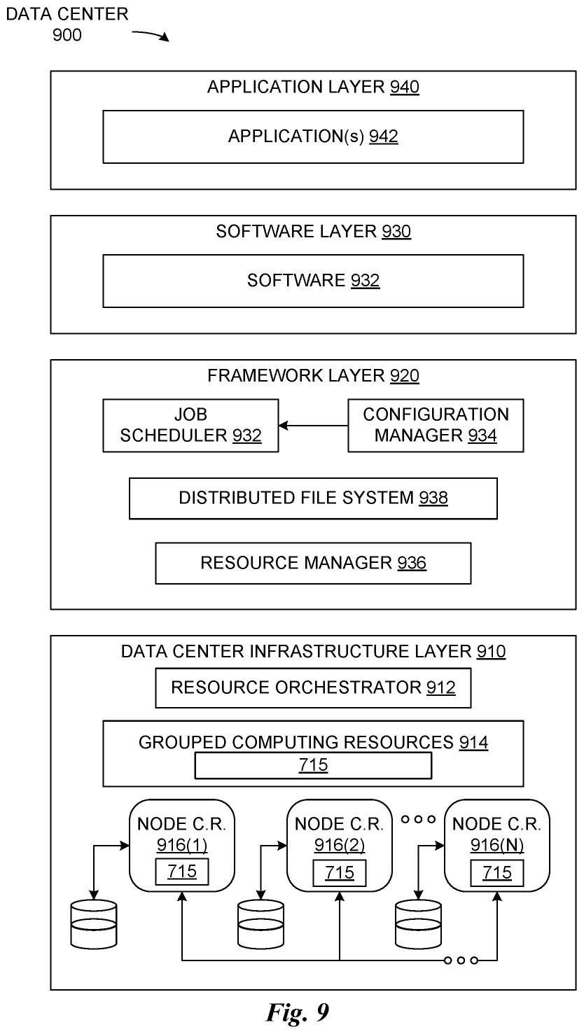

FIG. 9 illustrates an example data center 900, in which at least one embodiment may be used. In at least one embodiment, data center 900 includes a data center infrastructure layer 910, a framework layer 920, a software layer 930 and an application layer 940.

In at least one embodiment, as shown in FIG. 9, data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 916(1)-916(N) may be a server having one or more of above-mentioned computing resources.

In at least one embodiment, grouped computing resources 914 may include separate groupings of node C.R.s housed within one or more racks (not shown), or many racks housed in data centers at various geographical locations (also not shown). Separate groupings of node C.R.s within grouped computing resources 914 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 922 may configure or otherwise control one or more node C.R.s 916(1)-916(N) and/or grouped computing resources 914. In at least one embodiment, resource orchestrator 922 may include a software design infrastructure (“SDI”) management entity for data center 900. In at least one embodiment, resource orchestrator may include hardware, software or some combination thereof.

In at least one embodiment, as shown in FIG. 9, framework layer 920 includes a job scheduler 932, a configuration manager 934, a resource manager 936 and a distributed file system 938. In at least one embodiment, framework layer 920 may include a framework to support software 932 of software layer 930 and/or one or more application(s) 942 of application layer 940. In at least one embodiment, software 932 or application(s) 942 may respectively include web-based service software or applications, such as those provided by Amazon Web Services, Google Cloud and Microsoft Azure. In at least one embodiment, framework layer 920 may be, but is not limited to, a type of free and open-source software web application framework such as Apache Spark™ (hereinafter “Spark”) that may utilize distributed file system 938 for large-scale data processing (e.g., “big data”). In at least one embodiment, job scheduler 932 may include a Spark driver to facilitate scheduling of workloads supported by various layers of data center 900. In at least one embodiment, configuration manager 934 may be capable of configuring different layers such as software layer 930 and framework layer 920 including Spark and distributed file system 938 for supporting large-scale data processing. In at least one embodiment, resource manager 936 may be capable of managing clustered or grouped computing resources mapped to or allocated for support of distributed file system 938 and job scheduler 932. In at least one embodiment, clustered or grouped computing resources may include grouped computing resource 914 at data center infrastructure layer 910. In at least one embodiment, resource manager 936 may coordinate with resource orchestrator 912 to manage these mapped or allocated computing resources.

In at least one embodiment, software 932 included in software layer 930 may include software used by at least portions of node C.R.s 916(1)-916(N), grouped computing resources 914, and/or distributed file system 938 of framework layer 920. one or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 934, resource manager 936, and resource orchestrator 912 may implement any number and type of self-modifying actions based on any amount and type of data acquired in any technically feasible fashion. In at least one embodiment, self-modifying actions may relieve a data center operator of data center 900 from making possibly bad configuration decisions and possibly avoiding underutilized and/or poor performing portions of a data center.

In at least one embodiment, data center 900 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 900. In at least one embodiment, trained machine learning models corresponding to one or more neural networks may be used to infer or predict information using resources described above with respect to data center 900 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 715 are used to perform inferencing and/or training operations associated with one or more embodiments. In at least one embodiment, inference and/or training logic 715 may be used in system FIG. 9 for inferencing or predicting operations based, at least in part, on weight parameters calculated using neural network training operations, neural network functions and/or architectures, or neural network use cases described herein.

As described herein, a method, computer readable medium, and system are disclosed for neural network model sparsification. In accordance with FIGS. 1-6, embodiments may provide processes to generate and use sparse neural network models. The machine learning models may be stored (partially or wholly) in one or both of data storage 701 and 705 in inference and/or training logic 715 as depicted in FIGS. 7A and 7B. Training and deployment of the machine learning models may be performed as depicted in FIG. 8 and described herein. Distribution of the machine learning models may be performed using one or more servers in a data center 900 as depicted in FIG. 9 and described herein.

What is claimed is:

1. A method, comprising:
at a device, in an iteration of at least one iteration of a neural network model sparsification process:
training an active set of parameters in a neural network model from which a subset of parameters has been temporarily pruned;
estimating an importance of the subset of parameters temporarily pruned from the neural network model by freezing the active set of parameters in the neural network model and training the subset of parameters in the neural network model; and
updating the active set of parameters in the neural network model, based on the importance of the subset of parameters pruned from the neural network model.

2. The method of claim 1, where the device further:
prunes the subset of parameters from the neural network model prior to training the active set of parameters in the neural network model.

3. The method of claim 2, wherein the pruning is unstructured.

4. The method of claim 2, wherein the pruning is structured.

5. The method of claim 1, wherein a number of active parameters to be used during each iteration of the at least one iteration of the neural network model sparsification process is predefined.

6. The method of claim 1, wherein the neural network model is a sparse neural network model having a predefined number of active parameters.

7. The method of claim 1, wherein the active set of parameters are randomly selected for an initial iteration of the neural network model sparsification process.

8. The method of claim 1, wherein for each iteration of the at least one iteration of the neural network model sparsification process, a mask defines the active set of parameters and the subset of parameters pruned from the neural network model.

9. The method of claim 8, wherein estimating the importance of the subset of parameters pruned from the neural network model further includes re-activating the subset of parameters in the neural network model, and wherein the freezing and the re-activating is performed by updating the mask.

10. The method of claim 9, wherein the subset of parameters are re-activated with their most recently used value.

11. The method of claim 8, wherein updating the active set of parameters in the neural network model is performed by defining the updated active set of parameters in the mask.

12. The method of claim 1, wherein the active set of parameters are trained over a first plurality of iterations to stabilize the neural network model and to exploit the neural network model to improve its performance with respect to a defined performance goal, and wherein the subset of parameters are trained over a second plurality of iterations with an assumption of stability of the neural network model and to exploit the neural network model to maximize its performance with respect to the defined performance goal.

13. The method of claim 1, wherein an importance of the parameters in the active set of parameters is additionally estimated.

14. The method of claim 13, wherein the active set of parameters is further updated, based on the importance of the parameters in the active set of parameters.

15. The method of claim 14, wherein the active set of parameters are updated to include a defined number of parameters with highest importance from among the active set of parameters and the subset of parameters.

16. The method of claim 1, wherein updating the active set of parameters includes growing the active set of parameters with one or more of the parameters in the subset of parameters previously pruned from the neural network model.

17. The method of claim 1, wherein the device further:
performs an additional iteration of the neural network model sparsification process, based on the updated active set of parameters.

18. A system, comprising:
a non-transitory memory storage comprising instructions; and
one or more processors in communication with the memory, wherein the one or more processors execute the instructions, in an iteration of at least one iteration of a neural network model sparsification process, to:
train an active set of parameters in a neural network model from which a subset of parameters has been pruned;
estimate an importance of the subset of parameters pruned from the neural network model by freezing the active set of parameters in the neural network model and training the subset of parameters in the neural network model; and
update the active set of parameters in the neural network model, based on the importance of the subset of parameters pruned from the neural network model.

19. The system of claim 18, where the one or more processors further execute the instructions to:
prune the selected subset of parameters from the neural network model prior to training the active set of parameters in the neural network model.

20. The system of claim 18, wherein for each iteration of the at least one iteration of the neural network model sparsification process, a mask defines the active set of parameters and the subset of parameters pruned from the neural network model.

21. The system of claim 20, wherein estimating the importance of the subset of parameters pruned from the neural network model further includes re-activating the subset of parameters in the neural network model, and wherein the freezing and the re-activating is performed by updating the mask.

22. The system of claim 18, wherein the active set of parameters are trained over a first plurality of iterations to stabilize the neural network model and to exploit the neural network model to improve its performance with respect to a defined performance goal, and wherein the subset of parameters are trained over a second plurality of iterations with an assumption of stability of the neural network model and to exploit the neural network model to maximize its performance with respect to the defined performance goal.

23. The system of claim 18, wherein an importance of the parameters in the active set of parameters is additionally estimated, and wherein the active set of parameters are updated to include a defined number of parameters with highest importance from among the active set of parameters and the subset of parameters.

24. The system of claim 18, wherein updating the active set of parameters includes growing the active set of parameters with one or more of the parameters in the subset of parameters previously pruned from the neural network model.

25. The system of claim 18, where the one or more processors further execute the instructions to perform an additional iteration of the neural network model sparsification process, based on the updated active set of parameters.

26. A non-transitory computer-readable media storing computer instructions which when executed by one or more processors of a device cause the device, in an iteration of at least one iteration of a neural network model sparsification process, to:
train an active set of parameters in a neural network model from which a subset of parameters has been pruned;
estimate an importance of the subset of parameters pruned from the neural network model by freezing the active set of parameters in the neural network model and training the subset of parameters in the neural network model; and
update the active set of parameters in the neural network model, based on the importance of the subset of parameters pruned from the neural network model.
